(19) United States
(12) Patent Application Publication
(10) Pub. No.: US 2014/0279331 A1
(43) Pub. Date: Sep. 18, 2014

(54) SYSTEM AND METHOD FOR PRO-ACTIVELY RESPONDING TO MASS COMPROMISE SITUATIONS

(71) Applicant: Capital One Financial Corporation, McLean, VA (US)

(72) Inventors: Craig R. GIMBY, Chesterfield, VA (US); James D. O'BRIEN, Mechanicsville, VA (US)

(73) Assignee: Capital One Financial Corporation, McLean, VA (US)

(21) Appl. No.: 14/200,795

(22) Filed: Mar. 7, 2014

Related U.S. Application Data
(60) Provisional application No. 61/789,142, filed on Mar. 15, 2013.

(51) Int. Cl. G06Q 40/02

(52) U.S. Cl. CPC G06Q 40/02
USPC 705/35

(57) ABSTRACT

Systems and methods for automatically responding to a mass compromise event include storing, in a financial institution database, transaction histories for each of a plurality of accounts associated with the financial institution, analyzing, using an account detection processor, the transaction histories to identify one or more accounts among the plurality of accounts that are associated with a mass compromise event, segmenting, using the account detection processor, the identified one or more accounts into first and second segments, applying, using the account detection processor, risk splitters to first segment to identify mass compromise queue processing accounts, providing, using the account detection processor, the mass compromise queue processing accounts, and automatically processing, using a mass compromise queue processor, the mass compromise queue processing accounts.

### CROSS-REFERENCE TO RELATED APPLICATIONS

This application claims priority to U.S. Provisional Patent Application No. 61/789,142, filed on Mar. 15, 2013, the entire contents of which is incorporated herein by reference.

### FIELD OF THE DISCLOSURE

The present disclosure relates to systems and methods for proactively responding to mass compromise situations.

### BACKGROUND OF THE DISCLOSURE

Mass compromise situations can result in negative customer experiences and lost revenue on potentially compromised accounts during card transfers. These and other drawbacks exist.

### SUMMARY OF THE DISCLOSURE

Systems and methods for automatically responding to a mass compromise event include storing, in a financial institution database, transaction histories for each of a plurality of accounts associated with the financial institution, analyzing, using an account detection processor, the transaction histories to identify one or more accounts among the plurality of accounts that are associated with a mass compromise event, segmenting, using the account detection processor, the identified one or more accounts into first and second segments, applying, using the account detection processor, risk splitters to first segment to identify mass compromise queue processing accounts, providing, using the account detection processor, the mass compromise queue processing accounts, and automatically processing, using a mass compromise queue processor, the mass compromise queue processing accounts.

A system according to various embodiments includes a database that stores transaction histories for each of a plurality of accounts associated with a financial institution, a detection processor that analyzes the transaction histories to identify one or more accounts among the plurality of accounts that are associated with a mass compromise event, segments the identified one or more accounts into first and second segments, applies risk splitters to first segment to identify mass compromise queue processing accounts, and provides the mass compromise queue processing accounts, and a mass compromise queue processor that enables automatic processing of the mass compromise queue processing accounts. The system also may include a messaging processor that is associated with an email or SMS system to enable automatic contact of account holders.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system for automatically responding to mass compromise situations;

FIG. 2 depicts an example embodiment of a method of automatically responding to mass compromise situations; and

FIG. 3 depicts an example embodiment of automatically responding to mass compromise situations.

### DETAILED DESCRIPTION OF THE EMBODIMENTS

The following description is intended to convey a thorough understanding of the embodiments described by providing a number of specific example embodiments and details involving systems and methods for proactively responding to mass compromise situations. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial institution and system supporting a financial institution are used as examples for the disclosure. The disclosure is not intended to be limited to financial institutions only.

According to the various embodiments of the present disclosure, systems and methods enable a proactive response to mass compromise situations. The term “mass compromise” as referred to herein may refer to situations where a plurality of financial accounts have been compromised due to fraud or similar activity that may compromise the integrity of the financial accounts, for example. Specifically, one or more cards associated with the plurality of accounts may have been fraudulently compromised. Mass compromise may occur where one or more merchant databases containing customer account information have been compromised and customer account and personal information may have been copied or stolen. Mass compromise may occur when one or more merchant point of sale (POS) locations are physically compromised. For example, a fraudster may install one or more card reading devices or skimmers to steal credit card information by secretly reading the magnetic strip on a payment card.

The proactive response to one or more mass compromises may be automated to reduce the time it takes to respond, eliminate errors associated with manual response, and proactively shut down or restrict one or more financial accounts before they can incur fraudulent transactions. The response process may be automated using various systems and networks as described herein.

FIG. 1 depicts an example embodiment of a system 100 for proactively responding to one or more mass compromise situations. The system may include various network-enabled computer systems, including, as depicted in FIG. 1 for example, a financial institution 101; a mass compromise response system 102 comprising an Account Processor 103, a case management processor 104, a reissue processor 109, and one or more queues 105. In the example embodiment shown in FIG. 1, mass compromise response system 102 is disclosed as a separate component from financial institution 101. Other example embodiments may disclose system 102 as being integrated into financial institution 101. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to proactively respond to one or more mass compromise situations, as described herein. The depiction in FIG. 1 is an example only, and the functions and processes described herein may be performed by any number of network-enabled computers as part of a system for proactively responding to mass compromise situations. It is also noted that the system 100 illustrates only a single instance of each component. It will be appreciated that multiple instances of these components may be used. Moreover, the system 100 may include other devices not depicted in FIG. 1.

In various example embodiments, an account holder 106 may be any individual or entity that desires to conduct a financial transaction using one or more accounts held at one or more financial institutions. Also, an account holder may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, or mobile commerce account. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account card may be associated or affiliated with one or more social networking sites, such as a co-branded credit card.

In various example embodiments, a merchant 107 may be any retailer, wholesaler, point-of-sale (POS) location, or any other provider of goods or services. Merchant 107 may have one or more physical locations. Merchant 107 may be an online retailer. Merchant 107 may be any commercial or business entity where account holder 106 purchases goods or services using one or more financial accounts with financial institution 101.

Network 108 may enable communication between financial institution 101, mass compromise response system 102, one or more account holders 106, and one or more merchants 107. For example, Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the example types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

Referring to FIG. 1, account processor 103 may be configured to receive a batch of one or more compromised accounts. The compromised accounts may be financial accounts with one or more financial institutions, such as financial institution 101. The accounts may have been previously designated as fraudulently compromised. Financial institution 101 may supply the batch of compromised accounts to account processor 103. Merchant 107 may supply the batch of compromised accounts to account processor 103. A third party may supply the batch of compromised accounts. Account data may be included for each compromised account.

The account data may include account numbers and information identifying the one or more account holders 106 associated with the compromised accounts. Account data may include a bank identification number (BIN) for each card associated with the account. The account data may include a list of transactions performed using the account. The transactions may span a certain time period. The account data may include the amount charged for each transaction. The account data may include the geographic location where the transactions were performed, such as, for example, the street, city, state, county, zip code, country, region, time zone, or other relevant location information. The account data may include a data and time for each transaction. The account data may include merchant identifies that identify the merchant or POS location where each of the transactions were performed. The account data may indicate whether the transaction was performed at an Automatic Teller Machine (ATM). Account data may indicate whether the transactions included a signature. The account data may include the type of merchant, such as whether the merchant was a restaurant, an airline, a convenience store, clothing store, hardware, electronics, or other relevant types of merchants that offer goods and services in commerce.

The one or more compromised accounts in a batch may be stored in a format such as, for example, a flat file, an indexed file, a hierarchical database, a post-relational database, a relational database, such as a database created and maintained with software from, for example Oracle® Corporation, Microsoft® Excel file, Microsoft® Access file, or any other storage mechanism.

Case management processor 104 may determine a common purchase point of compromise (CPP) for one or more compromised accounts. A CPP may be a merchant or POS location, such as merchant 107, that has been compromised. A CPP may include a merchant id or other information identifying a merchant, such as merchant 107. Case management processor 104 may determine a CPP by comparing the account data of the one or more compromised accounts in a batch to find similarities. Case management processor 104 may search for accounts with transactions at the same merchant (based on the merchant ids in the account data for each account). Case management processor 104 may search for accounts with transactions from the same location, within a certain date range. Case management processor 104 may triangulate the account data from one or more compromised accounts to determine a CPP. Case management processor 104 may be configured to determine a CPP if a minimum of two compromised accounts share a common merchant or date range or other account data. The minimum number of compromised accounts that must share common transaction data in order for the case management processor 104 to determine a CPP may vary depending on the scenario.

Once case management processor 104 has determined a CPP, it may determine a compromise date range. The compromise date range may begin at the earliest date one of the compromised accounts in the batch performed a transaction at the CPP. The compromise date range may end at the last date that one of the compromised accounts in the batch performed a transaction at the CPP.

Once the case management processor 104 has determined a compromise date range and CPP, case management processor 104 may create a mass compromise queue, such as queue 105. The queue 105 may comprise one or more uncompromised financial accounts that have been used to perform transactions at the CPP. Case management processor 104 may receive a batch of one or more uncompromised accounts from financial institution 101, or from a third party. The batch of uncompromised accounts may comprise account data with similar informational categories as the compromised accounts received by the account processor 103. Case management processor may compare the account data for each of the uncompromised accounts with the CPP and compromise date range. The case management processor 104 may identify one or more uncompromised accounts that have been used to perform transactions as the CPP (based on the merchant id) within the compromise date range. The identified accounts may be flagged. “Flagging” an account may include adding a code to the account data indicating that the account is potentially compromised.

So for example, if the case management processor has identified a convenience store in Richmond, Va. as the CPP, and the compromise date range as Jan. 1, 2013-Jan. 15, 2013, the case management processor may search through a batch of uncompromised accounts for transactions performed at the identified convenience store between January 1 and Jan. 15, 2013. Any uncompromised account that meets this criteria will be flagged as potentially compromised and added to the mass compromise queue 105.

Once the case management processor 104 has created a mass compromise queue 105, it may then release the queue 105 for processing to a reissue processor 109. The queue 105 may be released once case management processor 104 has searched through the entire batch of uncompromised accounts. The reissue processor 109 may be configured to proactively close the one or more accounts contained in the mass compromise queue 105. The reissue processor 109 may be configured to deactivate the payment cards for each of the one or more accounts in the mass compromise queue 105. The reissue processor 109 may be configured to issue new payment cards for each of the accounts in the mass comp queue 105. Reissue processor 109 may restrict access to the flagged accounts. Reissue processor 109 may be configured to send a notification to the account holder 106 of an account in the mass comp queue 105. The notification may be an email, text, SMS, Facebook message, Tweet, or other form of electronic communication informing the account holder that the account is being closed and a new account is being created or a new card is being issued.

Case management processor 104 also may automatically add the entire batch of uncompromised accounts to the mass compromise queue 105 without flagging them. This may depend on the size of the batch. For example, if the batch contains fewer than 1,000 uncompromised accounts, case management processor 104 may automatically add the entire batch of uncompromised accounts to the mass compromise queue 105, which will then be sent to reissue processor 109.

FIG. 2 provides an example method 200 for implementing a response to a mass compromise situation. The method 200 shown in FIG. 2 can be executed or otherwise performed by one or more combinations of various systems. The method 200 as described below may be carried out by the system for implementing proactive responses to mass compromise situations as shown in FIG. 1, by way of example, and various elements of that system are referenced in explaining the method of FIG. 2. Each block shown in FIG. 2 represents one or more processes, methods, or subroutines in the example method 200. Referring to FIG. 2, the example method 200 may begin at block 210.

At step 210, a batch of compromised accounts may be retrieved. The compromised accounts may include account information, such as BIN numbers, account numbers, account holder identification, and a list of transactions performed on each account. The transaction list may include date and time of the transaction. The transaction list may include geographic location where the transactions were performed. The transaction list may include a transaction amount. The transaction list may include a merchant id that identifies the merchant or POS location where the transaction was performed. The batch may be received from one or more financial institutions, merchants, or third parties. Each of the accounts in the batch may have been previously flagged as fraudulent (or compromised) accounts.

At step 220, the mass compromise response system may determine one or more common purchase points of compromise (CPPs). The CPP may be determined by triangulating the account data for each of the compromised accounts to find similarities in transaction locations, merchants, date ranges, and other similar data points. In one example, the batch may comprise ten compromised accounts. The mass compromise response system may determine that four of those accounts all conducted a transaction at the same ATM in Alexandria, Va. within two days of each other. The mass compromise system may designate the ATM as a CPP.

At step 230, the mass compromise response system may determine a compromise date range. From the previous example, the mass compromise response system may determine the earliest date that any of the four compromised accounts performed a transaction at the CPP. In this example, the earliest date may be November 15. The mass compromise response system then may determine the last date that any of the four compromised accounts performed a transaction at the CPP. In this example, the latest date may be November 20. The mass compromise response system may determine the mass compromise date range of November 15-November 20. The date range may include a time of day.

At step 240, the mass compromise response system may flag one or more uncompromised accounts. The one or more uncompromised accounts may be received in one or more batches from one or more financial institutions or third parties. The one or more uncompromised accounts may have associated account data and transaction data. The mass compromise response system may compare the transaction data for the one or more uncompromised accounts with the CPP and compromise date range. If an uncompromised account includes a transaction at the CPP within the compromise date range, the response system may flag the account for restriction or reissuance. “Flagging” an account may include adding a code to the account data indicating that the uncompromised account is potentially compromised.

For example, mass compromise system may receive a batch of 100 uncompromised accounts. The mass compromise system may compare the account data for each of the 100 uncompromised accounts with the CPP and compromise date range. In the previous example, twenty of the uncompromised accounts may have conducted a transaction at the ATM in Alexandria (the CPP) between November 15 and November 20. Each of the twenty accounts may be flagged as potentially compromised.

At step 250, the mass compromise system may add the flagged accounts to a queue. The mass compromise system also may add all of the uncompromised accounts in the batch to a queue. This may occur if the number of accounts in the batch is under a certain threshold. For example, if the batch contains fewer than 500 accounts, the mass compromise system may automatically add all of the uncompromised accounts to the queue without flagging them.

At step 260, one or more of the flagged accounts in the queue may be processed for reissuance. Each of the flagged accounts in the queue may be closed and a new card may be issued to the account holder. In the example discussed above, each of the 20 flagged accounts may be closed or restricted. The mass compromise response system may issue one or more new payment cards to the account holder for each of the twenty accounts. Additionally, where the uncompromised accounts were automatically placed in the queue without being flagged, each account in the queue may be processed for reissuance.

The mass response system may send a notification to the account holder for one of the flagged accounts that the account is being restricted or closed. The notification may be an electronic communication, such as an email, text message, SMS, Facebook message, Twitter message (Tweet), or other form of electronic communication.

FIG. 3 provides an example method 300 for implementing a response to a mass compromise situation. The method 300 shown in FIG. 3 can be executed or otherwise performed by one or more combinations of various systems. The method 300 as described below may be carried out by the system for implementing proactive responses to mass compromise situations as shown in FIG. 1, by way of example, and various elements of that system are referenced in explaining the method of FIG. 3. Each block shown in FIG. 3 represents one or more processes, methods, or subroutines in the example method 300. Referring to FIG. 3, the example method 300 may begin at block 302.

In block 302, compromised accounts may be detected. For example, investigators associated with a financial institution (e.g., financial institution 101). In various example embodiments, investigators, using various hardware processors and software modules, for example, may use a CPP and/or phantom process to determine whether accounts are compromised and injectable. According to an example CPP process, accounts may be reviewed and tagged as fraudulent so that investigators may work backward to identify the source of the fraud. For example, using the CPP process, investigators using various hardware processors and software modules, for example, may begin with accounts having card present fraud and a threshold amount of money. Investigators, using various hardware processors and software modules, for example, may then apply certain risk splitters to identify the most toxic among the compromised accounts. A CPP script then may be used to obtain all of the accounts transacted at these merchants within a certain timeframe. According to an example phantom process, investigators, using various hardware processors and software modules, for example, may identify merchants that have the same identifier and different merchant names. Using various hardware processors and software modules, for example, known good merchants may be excluded from the list. Then, using various hardware processors and software modules, for example, authorization data for a particular timeframe (e.g., the past 2 years) may be reviewed to determine whether and of the merchants that have the same identifier and different merchant names are good merchants. Merchants with unusual patters, such as city and zip code mismatches and/or merchants having “#”, for example, in the name, may be targeted using various hardware processors and software modules, for example. A phantom script then may be used to obtain all accounts transacted at the identified merchants. For injectable accounts, method 300 may proceed to block 304. For non-injectable accounts, those accounts may be flagged, identified or otherwise indicated as high risk in block 310.

In block 304, injectable accounts may be segmented and/or scrubbed using various benchmarks. In various example embodiments, a financial institution may not desire to have sensitive accounts injected into the automatic mass compromise processing queue. For example, a financial institution may not want high value customers (e.g., a customer with a $10 million dollar relationship with the financial institution), corporate customers, and/or other customers to be processed automatically. Using various hardware processors and software modules, for example, these accounts may be reviewed and segmented out from automatic processing. The segmented accounts may then be processed manually.

In block 306, risk splitters may be applied to identify the accounts that will be injected into the mass compromise processing queue. Risk splitters may include, for example, date range, volume and velocity or other like risk metrics that may be used to maintain a manageable number of accounts for automatic mass compromise processing.

In block 308, fraudulent accounts may be injected into the mass compromise queue for automatic processing. The fraudulent accounts may include, for example, those accounts detected by the CPP and/or phantom detection processes, are not segmented for manual processing, and satisfy the various risk metrics applied.

In block 310, accounts that are not injectable or not injected, but may have suspicious activity associated therewith may be flagged with a mass compromise flag or indicator.

In block 312, a case may be created for each account in the mass compromise queue. For example, a database entry or other electronic record may be created to enable processing of the account in the mass compromise queue.

In block 314, during mass compromise queue processing, a financial institution may attempt to contact an account holder associated with the mass compromised account. For example, a financial institution may use email, messaging (via, e.g., text, push notification, or other like messaging), and or telephone (using, for example, an automatic dialer and/or voice response unit) to notify the account holder that an associated account is subject to a mass compromise. If the account holder is contacted, method 300 may proceed to block 318. If the account holder is not contacted, method 300 may proceed to block 316.

In block 318, contact processing may be performed. Contact processing may include, for example, determining whether the account holder understands the nature of the mass compromise situation. If so, a new account number (e.g., a new credit card number), may be issued (or re-issued) on an expedited basis. If, for some reason, the account holder cannot incur the troubles associated with a reissue (e.g., card downtime, travel related reasons, etc.) other processing options may be employed to resolve the risks associated with using an account that is subject to a mass compromise event.

In block 316, if contact is not made, it may be determined whether fraud on the account is suspected. If so, in block 322, the account may automatically be restricted by the financial institution. If fraud is not suspected, the financial institution may attempt to contact the account holder in block 320, which may proceed to block 314.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A system, comprising:
a database that stores transaction histories for each of a plurality of accounts associated with a financial institution;
a detection processor that analyzes the transaction histories to identify one or more accounts among the plurality of accounts that are associated with a mass compromise event, segments the identified one or more accounts into first and second segments, applies risk splitters to first segment to identify mass compromise queue processing accounts, and provides the mass compromise queue processing accounts; and
a mass compromise queue processor that enables automatic processing of the mass compromise queue processing accounts.

2. The system of claim 1, further comprising:
a messaging processor that attempts to contact account holders associated with respective mass compromise queue processing accounts.

3. The system of claim 2, further comprising:
an automatic dialer associated with the messaging processor that automatically dials a number associated with each of the respective account holders.

4. The system of claim 2, further comprising:
a messaging agent associated with the messaging processor that automatically transmits a message to each of the respective account holders.

5. The system of claim 4, wherein the messaging agent is an email system.

6. The system of claim 4, wherein the messaging agent is a short message service (SMS) system.

7. The system of claim 2, wherein, if the messaging processor receives an indication that one of the account holders could not be contacted, a fraud processor determines whether fraud is suspected on the account holder's account and automatically restricts the account if the fraud processor determines that fraud is suspected.

8. The system of claim 1, wherein the detection processor identifies one or more accounts among the plurality of accounts that are associated with a mass compromise event by identifying one or more common points of purchase associated with a mass compromise event.

9. The system of claim 1, wherein the detection processor identifies one or more accounts among the plurality of accounts that are associated with a mass compromise event by identifying merchants that have a city and zip code mismatch.

10. The system of claim 1, wherein the detection processor flags accounts other than the mass compromise queue processing accounts as being high risk accounts.

11. A method, comprising:
storing, in a financial institution database, transaction histories for each of a plurality of accounts associated with the financial institution;
analyzing, using an account detection processor, the transaction histories to identify one or more accounts among the plurality of accounts that are associated with a mass compromise event;
segmenting, using the account detection processor, the identified one or more accounts into first and second segments;
applying, using the account detection processor, risk splitters to first segment to identify mass compromise queue processing accounts;
providing, using the account detection processor, the mass compromise queue processing accounts; and
automatically processing, using a mass compromise queue processor, the mass compromise queue processing accounts.

12. The method of claim 11, further comprising:
attempting to contact, using a messaging processor, account holders associated with respective mass compromise queue processing accounts.

13. The method of claim 12, further comprising:
using an automatic dialer associated with the messaging processor to automatically dial a number associated with each of the respective account holders.

14. The method of claim 12, further comprising:
using a messaging agent associated with the messaging processor to automatically transmit a message to each of the respective account holders.

15. The method of claim 14, wherein the messaging agent is an email system.

16. The method of claim 14, wherein the messaging agent is a short message service (SMS) system.

17. The method of claim 12, wherein, if the messaging processor receives an indication that one of the account holders could not be contacted, a fraud processor determines whether fraud is suspected on the account holder's account and automatically restricts the account if the fraud processor determines that fraud is suspected.

18. The method of claim 11, wherein the detection processor identifies one or more accounts among the plurality of accounts that are associated with a mass compromise event by identifying one or more common points of purchase associated with a mass compromise event.

19. The method of claim 11, wherein the detection processor identifies one or more accounts among the plurality of accounts that are associated with a mass compromise event by identifying merchants that have a city and zip code mismatch.

20. The system of claim 1, using the detection processor to flag accounts other than the mass compromise queue processing accounts as being high risk accounts.
